(19) United States
(12) Patent Application Publication
(10) Pub. No.: US 2025/0327214 A1
(43) Pub. Date: Oct. 23, 2025

(54) Composition and Elongated Line Device Useful for Various Devices Such as Trimmer Lines, Fishing Lines and the Like

(71) Applicant: Arnaldo R. Garcia, JR., Sterling Heights, MI (US)

(72) Inventor: Arnaldo R. Garcia, JR., Sterling Heights, MI (US)

(21) Appl. No.: 19/184,407

(22) Filed: Apr. 21, 2025

Related U.S. Application Data
(60) Provisional application No. 63/637,197, filed on Apr. 22, 2024.

(51) Int. Cl. D01F 8/02; A01D 34/416; A01K 91/00; D01D 5/34

(52) U.S. Cl. CPC D01F 8/02; A01D 34/4168; A01K 91/00; D01D 5/34; D10B 2201/28; D10B 2401/063; D10B 2505/00; D10B 2507/00

(57) ABSTRACT

An elongated line device that includes an elongated core and a sheath surrounding and connected to the elongated core. The elongated core includes a polymer selected from the group consisting of a high molecular weight strain hardened polymeric matrix, a cellulose-derived fiber matrix and mixtures thereof. The sheath includes an amorphous polymeric matrix comprising cellulous ester and at least one plasticizer.

This present application is a United States Non-Provisional Patent Application that claims the benefit and claims priority to U.S. Provisional Patent Application Ser. No. 63/637,197, filed Apr. 22, 2024, the specification of which is incorporated by reference herein.

### BACKGROUND

This disclosure pertains to elongated synthetic line device constructs and methods of making the same. The synthetic elongated line device constructs disclosed herein can have a variety of applications including, but not limited to, use in fishing applications such as fishing line ropes and attachments, restrengthening of various shapes and size materials such as tubes and cylinders or square tubing through coiling or wrapping as well as use as string trimmer line in string trimmer devices.

Various applications require the use of synthetic elongated line device constructs, particularly synthetic elongated line devices having average diameters less than 25 mm. Non-limiting examples of such applications include various outdoor uses such as fishing line, netting, use in string trimmers and the like. All too often, devices employing synthetic elongated line constructs, particularly devices having outdoor applications can break or be discarded, resulting in fragments or larger synthetic elongated line device constructs that are lost into the environment at large.

Heretofore, synthetic elongated line device constructs have been composed of polymers such as nylon and the like with limited biobased material content. Heretofore, the use of polymers having biobased content in synthetic elongated line device constructs was problematic and considered undesirable where strength and/or durability were required such as fishing lines, netting and trimmer lines. It would be desirable to provide a synthetic elongated line device construct that can be composed in whole or in part of one or more biobased polymers that include the sufficient strength and/or durability to be employed in applications including but not limited to fishing lines fishing nets, and/or trimmer lines.

In applications including but not limited to fishing line, fishing nets and string trimmer devices, amounts of the elongated line device contract employed can find its way into the environment at large either by improper disposal or by breakage or fragmentation of the elongated line device construct during operation or use. The polymeric materials typically used in the synthetic elongated line device construct such as nylon and the like exhibit limited or degradability. The elongated line device construct as well as fragments and micro-fragments that are generated create an environmental burden and increase the potential for uptake into water systems and food chains in various ecosystems. Even materials that are disposed of in an environmentally responsible manner produce additional material that ends up in landfills and the like. Thus, it would be desirable to provide an elongated synthetic line device or material that is composed of polymeric material that can be biodegraded in whole or in part. It is also desirable to provide an elongated synthetic line device or material that can reduce load in landfills and/or can biodegrade if portions or fragments are introduced into the environment.

One such use for elongated synthetic line material is in string trimmer devices. String trimmer devices can be motor-driven devices for mowing grass, trimming grass or weeds or other plants. A mowing head is driven and rotated by an electric or combustion motor. As a result, a cutting device connected to the mowing head rotates at high speed and cuts the grass without a counter blade or a counter bearing. Cutting can be accomplished by a rotating line or filament.

In many applications, nylon lines have been employed as the cutting element in various string trimmer devices. Nylon line exhibits low brittleness and flexibility that can be useful for mowing operations. Nylon is a synthetic fiber that possesses limited biodegradability. The nylon line that is used can erode and break especially when hitting rock, steel or aluminum fencing during trimming or mowing operations and the like generating numerous fragments that are launched into the surrounding environment. These string trimmer fragments can range in size from microns and submicron pieces to fragments that are fractions of millimeters or greater. Some or all of the fragments produced during mowing operations can remain in the grass and soil indefinitely. Their small size makes it difficult, if not impossible to locate and collect these fragments after mowing operations and cannot be practically recycled. Thus, the polymeric components of the string trimmer line can remain in the environment for months or years and present the possibility of ingestion by wildlife and/or entry into the surrounding water system where it can be ingested by the population at large.

Synthetic elongated line device constructs composed of polymeric materials can have other advantageous uses and applications including, but not limited, to fishing line and the like. In order to be useful, synthetic elongated line device constructs must have suitable strength and resistance to stretch and flex. Heretofore material such as nylon have been proposed and employed. Polyamide materials such as nylon have limited or no biodegradability. Material that is broken or otherwise introduced into the environment can pose hazards such as pollution and ingestion into the food chain. Because synthetic elongated line device constructs remain relatively intact in the environment at large, abandoned material poses hazards to wildlife from ingestion, entanglement and the like

Thus, it would be desirable to provide an elongated line device or construct having characteristics including but not limited to enhanced strength, durability, toughness and the like. It would also be desirable to provide an elongated line device that exhibits elevated levels of post-use degradability, particularly when present as fragments and pieces in the outdoor environment. It would be desirable to provide an elongated line device suitable for use in applications such as fishing line and the like that. It would also be desirable to provide an elongated line device having one or more of the aforementioned characteristics suitable for use in a string trimmer device. It is also desirable that the products of degradation have limited negative impact on the environment and associated ecosystems.

### SUMMARY

The present disclosure is directed to elongated constructs such as elongated line devices and compositions useful in items including but not necessarily limited to fishing line, string trimmer line and the like.

In certain embodiments the elongated line device includes at least one first layer composed of an amorphous polymeric matrix comprising cellulose ester and at least one second layer composed of a polymeric material that differs from the amorphous polymeric matrix comprising cellulose ester of the first layer. In certain embodiments, the first layer has an outer surface and wherein the second layer is in overlying relationship to the first layer with the first layer is configured as a central core and the second layer is axially disposed relative to the first layer. In certain embodiments the elongated line device can include an elongated core and a sheath surrounding the elongated core. The elongated core is composed of a polymer that includes a high molecular weight strain hardened polymeric matrix, and mixtures thereof. The sheath surrounding the elongated core is composed of polymeric matrix composed of a cellulose ester polymer. In certain embodiments, the amorphous polymeric matrix of the first layer is a polymer can have a melt temperature greater than greater than 120° C. and a glass transition temperature greater than 85° C. In certain embodiments, the amorphous polymeric matrix of the sheath is composed of a cellulose ester selected from the group consisting of cellulose acetate, cellulose acetate butyrate, cellulose acetate propionate and mixtures thereof. In certain embodiments, the second layer can comprise a polymer selected from a group consisting of polyethylene, polycarbonate and mixtures thereof.

In certain embodiments, the elongated line device can further include an elongated core disposed axially interior to the first layer such that the first layer forms a sheath surrounding and connected to the elongated core, the elongated core composed of at least one strand of a polymer comprising a high molecular weight strain hardened polymeric matrix. In certain embodiments, the high molecular weight strain hardened polymeric matrix of the elongated core comprises polyphenylene terephthalamide, ultra-high molecular weight polyethylene and mixtures thereof. In certain embodiments, the polyphenylene terephthalamide is selected from the group consisting of meta-polyphenylene terephthalamide, para-polyphenylene terephthalamide, and mixtures thereof.

In certain embodiments, there is disclosed an elongated line device that includes elongated core, a sheath surrounding the elongated core, and an optional outer layer surrounding the sheath. The elongated core is composed of a polymer that includes a high molecular weight strain hardened polymeric matrix, and mixtures thereof. In certain embodiments, the sheath surrounding the elongated core is composed of polymeric matrix composed of a cellulose ester polymer having a melt temperature greater than greater than 120° C. and a glass transition temperature greater than 85° C. In certain embodiments, the amorphous polymeric matrix of the sheath is composed of a cellulose ester selected from the group consisting of cellulose acetate, cellulose acetate butyrate, cellulose acetate propionate and mixtures thereof. In certain embodiments, the high molecular weight strain hardened polymeric matrix can comprise polyphenylene terephthalamide, ultra-high molecular weight polyethylene and mixtures thereof. In certain embodiments, the polyphenylene terephthalamide can be selected from the group consisting of meta-polyphenylene terephthalamide, para-polyphenylene terephthalamide, and mixtures thereof. In certain embodiments the elongated line device can further include an optional outer coating layer composed of a polymer selected from the group consisting of polyethylene, polycarbonate and mixtures thereof.

### BRIEF DESCRIPTION OF THE DRAWING

The present disclosure can be understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is longitudinal cross-sectional view of a representative section of a first implementation of the elongated line device as disclosed herein taken along a longitudinal axis;

FIG. 2A is an axial cross-sectional view of the elongated line device of FIG. 1 taken through its diameter;

FIG. 2B is an axial cross section of a second implementation of the elongated line device as disclosed herein through its diameter;

FIG. 3A is an axial cross-sectional view of a third implementation of the elongated line device as disclosed herein taken along its diameter;

FIG. 3B is an axial cross-sectional view of a fourth implementation of the elongated line device as disclosed herein taken along its diameter;

FIG. 4 is a detail view of the elongated line device of FIG. 1;

FIG. 5 is an illustration of the elongated line device of FIG. 1 in early stages of degradation;

FIG. 6 is an illustration of an embodiment of the elongated line disclosed herein with the sheath layer partially removed illustrating multiple fiber strand bundle in the elongated core;

FIG. 7 is an illustration of a portion of the elongated line device as disclosed herein in which a portion of the sheath layer is removed and separation of the individual filaments in the elongated core have begun separation;

FIG. 8 is an illustration of a portion of the elongated line device as disclosed herein in which a portion of the sheath layer is removed and extreme separation has commenced;

FIG. 9 is a process diagram illustrating an embodiment of the method for producing an elongated line device as disclosed herein;

FIG. 10 is a cross-sectional diagram of an exemplary co-extrusion head suitable for producing various embodiments of the elongated line device as disclosed herein; and

FIG. 11 is a depiction of a line trimmer device employing an embodiment of the elongated line device as disclosed herein.

### DETAILED DESCRIPTION

The present disclosure is directed to elongated line device constructs and devices as well as processes for making the same. The present disclosure is also directed to devices that employ the elongated line device as disclosed including but not limited to string trimmer line, fishing line, fishing netting and the like as well as a device employing the same.

In certain embodiments, the elongated line device can be composed of one or more polymers that are produced in whole or in part from bio-derived material content and/or can be composed of materials that are, in whole or in part, degradable in an environmentally compatible manner. The elongated line device as disclosed herein can be employed in a variety of end-use applications, particularly ones that benefit from high strength, light weight elongated line constructs having enhanced biodegradability characteristics. These can include string trimmer line, fishing line by way of non-limiting example. Other end-use applications of the elongated line device contemplated based upon the present disclosure.

The present disclosure is based at least in part on the unexpected discovery that effective elongated line constructs can be prepared that exhibit biodegradability and have sufficient use characteristics that is effective in applications that require strength, toughness and durability characteristics of the elongated line device. The present disclosure is also predicated at least one part on the unexpected discovery that biobased and/or bioderived polymers can be employed in elongated line device constructs such as those disclosed herein to provide a serviceable and rugged end use device. Heretofore biobased and/or bioderived polymers such as amorphous polymeric cellulose esters, for example cellulose acetate, cellulose acetate butyrate, cellulose acetate propionate and mixtures thereof have been considered difficult to work with and process in elongated line device manufacturing. Additionally, it has been thought that material such as amorphous polymeric cellulose esters such as cellulose acetate, cellulose acetate butyrate, cellulose acetate propionate and the like as well as polymeric materials composed of various mixtures of these components would lack the toughness and durability necessary to function in in end use application employing elongated line constructs. These include but are not limited to use as fishing line, fishing netting, use in string trimmer devices and the like. The present disclosure is predicated, at least in part on the unexpected discovery that amorphous polymeric matrix materials comprising cellulose ester compounds can provide functional and durable elongated line device constructs.

As broadly construed, the elongated line device as disclosed herein can include at lest one first layer composed of amorphous polymeric matrix comprising cellulose ester compounds and at least one second layer composed of a polymeric material that differs from the amorphous polymeric matrix comprising cellulose ester of the first layer. The at least one first layer and the at least one second layer can both extend longitudinally along the length of the elongated lone device such that at least one of the first layer and at least one of the second layer are in contact with one another. The elongated line device can have any suitable cross-sectional profile including but not limited to circular, ovoid, rectangular, ridges, angles, and the like. The first layer, second layer or both may present a constant longitudinal thickness in certain embodiments. It is also contemplated that the thickness of one or both layers can vary within desired or required tolerances.

The first layer that is composed of amorphous polymeric matrix comprising cellulose esters can be a polymer having a melt temperature greater than greater than 120° C. and a glass transition temperature greater than 85° C. In certain embodiments, the cellulose ester polymer selected from a group consisting of cellulose acetate, cellulose acetate butyrate, cellulose acetate propionate and mixtures thereof. Without being bound to any theory, it is believed that in some embodiments, the cellulose ester polymer that is employed can be composed of components such as cellulose which are naturally derives as from plant-based material.

In certain embodiments, the first layer can be positioned and configured as the central core element with the at least one second layer axially disposed around it in overlying relationship thereto. In certain embodiments, the first layer can be disposed around a central core component with the second layer disposed around the first layer in overlying relationship thereto with the first layer forming a sheath in which the elongated core component is disposed and the at least one second layer forming a cover coating overlying the sheath.

In embodiments having an elongated core, it is contemplated that the elongated core can be composed of a suitable polymeric material that can provide characteristics such as additional tensile strength to the elongated line device. In certain embodiments, the elotnaged core and be composed of a polymeric material that comprises a high molecular weight, strain hardened polymeric matrix. In certain embodiments, the high molecular weight strain hardened polymeric matrix of the elongated core comprises polyphenylene terephthalamide, ultra-high molecular weight polyethylene and mixtures thereof. In certain embodiments, the polyphenylene terephthalamide material can be selected from the group consisting of meta-polyphenylene terephthalamide, para-polyphenylene terephthalamide, and mixtures thereof. Where desired or required, the elongated core can also include a suitable plasticizer material as desired or required. The sheath surrounding the elongated core can be composed of a polymeric material that comprises cellulose ester.

A non-limiting first embodiment of an elongated device is illustrated in FIG. 1, where there is depicted a portion of an elongated line device 10 that includes an elongated core 12 that is surrounded by a first layer that is configured sheath 14. The elongated line device 10 can be of any suitable length and may have an axial cross-sectional configuration configured in a suitable geometry for the intended end use. Non-limiting examples of suitable cross-sectional geometries include circular or ovoid. Other configurations such as those suitable for use in trimmer line applications are also contemplated for achieving or enhancing the cutting action of the string trimmer line and associated device.

The elongated line device as depicted in FIG. 1 has a generally circular or ovoid cross-section. However cross-sectional configurations such as those that define one or more longitudinal sharp edges are also considered to be within the purview of this disclosure. Non-limiting examples of such cross-sectional configurations include triangular, rectilinear and the like.

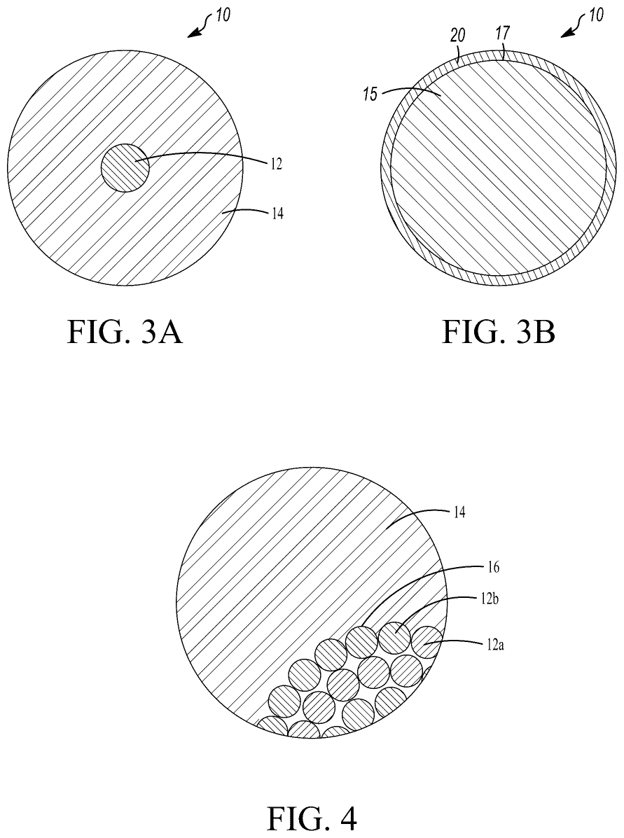

The elongated core 12 can be composed of one or more elongated strands composed of the high molecular weight strain hardened polymeric matrix. A cross-sectional depiction of an embodiment of the elongated line device 10 having a single strand elongated core 12 is depicted in FIG. 3. Where multiple elongated strands are employed in the elongated core 12, the individual strands can be composed of the same or different polymeric materials. Where multiple elongated strands are employed in the elongated core 12, the individual strands can be composed of the same or different polymeric materials and non-polymeric materials. The one or more elongated strands material or mixtures of fibers employed in the elongated core 12 can be those that individually or in combination provide an elongated core 12 having following general material characteristics at standard temperature and pressure: Tensile strength at yield between 0.02 and 4.0 GPa; Tensile modulus between 5×10⁶ psi and 19×10⁶ psi; Relative density between 1.3 and 1.5 g/cm; Extension at break between 1.0 and 5.0%. In certain embodiments, suitable materials can have a specific density between 0.03 and 0.07 lb/in². In certain embodiments, it is contemplated that the general material characteristics based on measurement of core bundles composed of between 750 and 1000 fibers having a denier between 900 and 1700 grams/9 km.

The Non-limiting examples of suitable a high molecular weight, strain-hardened polymeric matrix material employed in the elongated core 12 and/or in fibers used in the elongated core 12 can include polyphenylene terephthalate, ultra-high molecular weight polyethylene and mixtures thereof. Where desired or required, the high molecular weight strain-hardened polymeric matrix can be a para-aramid such as polyphenylene terephthalamidean materials selected from the group consisting of poly-meta-phenylene terephthalamide, poly-meta-phenylene terephthalamide, and mixtures thereof. Examples of such materials include those commercially available under the tradename KEVLAR. Suitable high molecular weight strain hardened polymeric matrix materials can include various para poly aramides such as various AABB poly-para aramides, for example p-phenylene terephthalamidean (PpPTA) materials commercially available under the tradename TWARON and meta polyaramides which is believed to be commercially available under the tradename such as NOMEX.

In certain embodiments, the one or more strands 12a, 12b composed of the high molecular weight strain hardened polymeric matrix will be present in the elongated core 12 as a long fiber material or as a long fiber yarn construct. As used herein the term “yarn” is defined as a bundle of individual filaments. Non-limiting examples of high molecular weight strain hardened polymeric matrix fibers include those having mechanical and physical characteristics as outlined in Table I and can include those composed of one or more of polyphenylene terephthalamide materials such as KEVLAR 29, KEVLAR 49, KEVLAR 129, KEVLAR 149 commercially available from DuPont.

TABLE I
Mechanical and Physical Properties of
Certain Terephthalamide Fiber Materials

| | Tensile | Relative | Tensile | Extension | Represen- |
|---|---|---|---|---|---|
| Characteristic | Modulus | Density | strength | at break | tative |
| (GPa) | (GPa) | (g/cm³) | (GPa) | (%) | material |
| Regular | 71 | 1.43 | 2.8 | 4.5 | Kevlar 29 |
| High modulus | 134 | 1.46 | 2.8 | 2.9 | Kevlar 49 |
| High strength | 98 | 1.46 | 3.5 | 3.2 | Kevlar 129 |
| Ultra-high | 144 | 1.48 | 2.4 | 1.6 | Kevlar 149 |
| modulus | | | | | |

Suitable ultrahigh molecular weight polyethylene (UHMWPE) that can be employed in the elongated core 12 are thermoplastic polymeric materials that are synthesized from materials such as monomeric ethylene and can also be referred to as high-modulus polyethylene. Materials that can be employed herein include those having a molecular mass between 3.5 and 7.5 amu. Suitable material can be present as elongated fibers and is commercially available from companies such as Avient of Avon Lake Ohio under the tradename DYNEEMA.

Examples of certain suitable mechanical and physical characteristics for UHMWPE materials can be found in Table II.

TABLE II
Mechanical and Physical Properties
of Certain UHMWPE Fiber Material

| | Tensile | Tensile | Elongations at |
|---|---|---|---|
| Fiber type | strength GPa | modulus GPa | break % |
| SK 78 | 3.3-3.9 | 109-132 | 3-4 |
| SK 75 | 3.3-3.9 | 109-132 | 3-4 |
| SK 65 | 2.4-3.3 | 65-100 | 3-4 |
| SK 62 | 2.4-3.3 | 65-100 | 3-4 |
| SK 60 | 2.4-3.3 | 65-100 | 3-4 |
| SK 25 | 2.2 | 52 | 3-4 |

In certain embodiments, the elongated core 12 can be composed of one or more individual fibers 12a, 12b, with one or more of the fibers being composed of the aforementioned material having an average diameter between 1 and 1000 microns, with average diameters between 5 and 500 microns, between 5 and 100 microns, between 5 and 50 microns in certain applications.

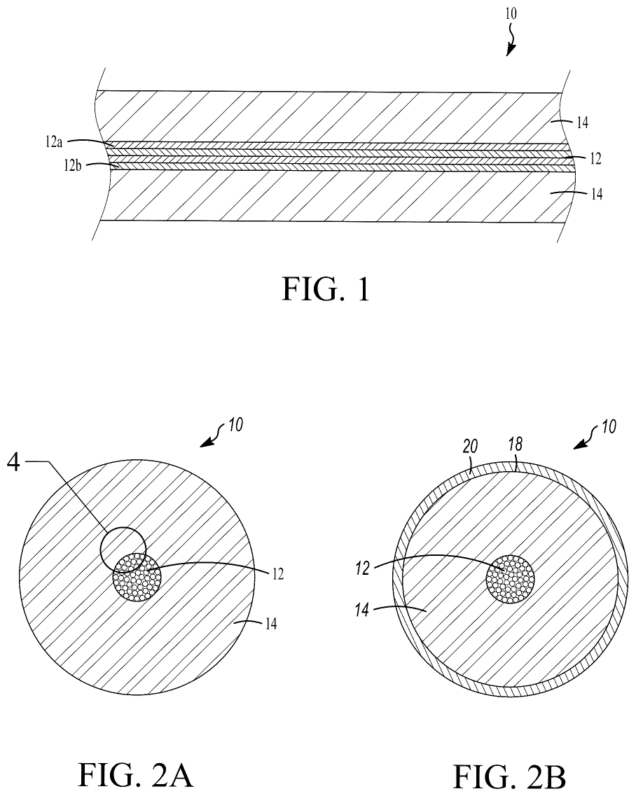

In certain embodiments the elongated core can be composed of multiple strand 12a 12b composed of the same polymeric material as illustrated in FIGS. 2 and 4. It is also considered to be with the purview of the present disclosure that the core 12 is composed of a single elongated fiber as illustrated in FIG. 3.

It is also within the purview of the present disclosure that the elongated core 12 can include one more naturally occurring fiber strands if desired or required. Non-limiting examples of naturally occurring fibers include cellulosic fibers such as cotton, linen, wool as well as other wood and plant derived fibers. Wood and plant-derived fibers can also include manufactured cellulose-derived fibers such as rayon, viscose and the like. Where present, these naturally occurring fiber strands will present in addition to the polymeric strands described herein. In certain embodiments, the naturally occurring fibers can constitute between 0.1% and 50% of the fiber bundle of elongated core 12, between 0.1 and 20% of the fiber bundle of elongated core 12; between 0.1 and 10% of the fiber bundle of elongated core 12; between 0.1 and 5% of the fiber bundle of elongated core 12; between 0.1 and 2% of the fiber bundle of elongated core 12; between 0.1 and 1% of the fiber bundle of elongated core 12; between 0.1 and 0.5% of the fiber bundle of elongated core 12.

Where multiple strands are employed in the elongated core 12, the various strands can be oriented relative to one another in any suitable configuration that will facilitate one or more objectives of strength, flexibility, or the like. Non-limiting examples of configurations include simple right or left twists as well as more complex lay types such as right-hand ordinary lay, left-hand ordinary lay patterns, right-hand Langs lay patterns, left-hand Langs lay patterns and the like.

The elongated core 12 can have a diameter sufficient to provide structural integrity and strength to the elongated line device 10. The ratio of core diameter to total average diameter of the elongated line device can vary based on the desired end-use application. In certain embodiments, the diameter of the elongated core 12 can constitute between 1% and 50% of the total average diameter of the elongated line device 10. In certain embodiments, the elongated core 12 constitutes between 5% and 45% of the diameter of the elongated core device 10; between 5% and 40% of the diameter; between 5% and 35%; between 5% and 30% of the diameter; between 5% and 25%; between 5% and 20%; between 5% and 15% between 5% and 10%; between 5% and 8%; between 7% and 50%; between 7% and 40%; between 7% and 30%; between 7% and 20%; between 7% and 10%; between 10% and 50%; between 10% and 40%; between 10% and 30%; between 10% and 20%; between 10% and 15%; between 15% and 50%; between 15% and 40%; between 15% and 35%; between 15% and 30%; between 15% and 20%.

The multiple strands or filaments such as strand 12a and strand 12b present in the elongated core 12 may be of the same or similar filament diameter where desired or required. It is also contemplated that the multiple filaments can have different diameters.

In certain embodiments, elongated core 12 the can be composed filaments or strands of the same polymeric material or can be composed of filaments of different but compatible polymeric material. To illustrate this, the device depicted in FIG. 1, the elongated core 12 is illustrated as being composed of two or more elongated strands or filaments such as strands 12a, 12b which are illustrated as being disposed in in a right twisted configuration. It is understood that the strands 12a, 12b can be twisted, braided, woven or otherwise oriented relative to one another to produce the elongated core 12. In certain configurations the various strands 12a, 12b can be identical to one another, i.e. can have of the same average diameter and/or be composed of the same polymeric material. In other configurations, the strands 12a, 12b can be vary from one another. “Strand variability” in the elongated core 12, as this term is employed in this disclosure, contemplates elongated cores composed of individual strands composed of the same material having different average diameters, strands having the same average diameter but composed of different materials, strands composed of different materials and different average diameters, etc. While the individual strands are depicted as strands 12a, 12b in FIGS. 1 and 4, it is contemplated that the elongated core 12 can be composed of strands exhibiting three or more different characteristics, four or more different characteristics, etc.

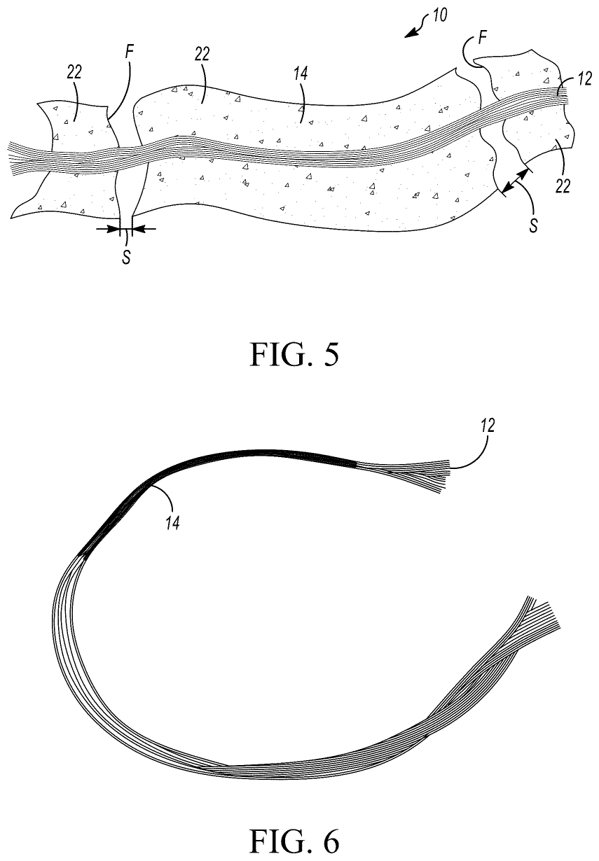

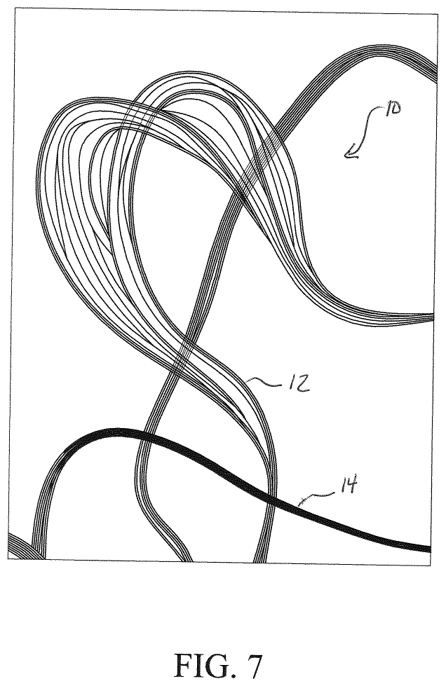

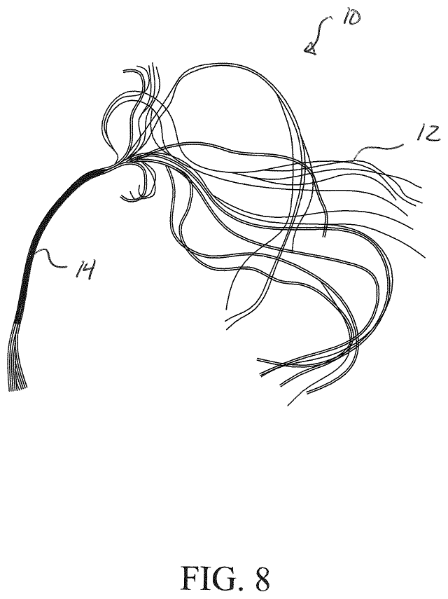

In certain embodiments, where the elongated core 12 is composed multiple individual elongated strand members or filaments, it is contemplated that the number of elongated strand members present in the elongated core 12 will be between 100 and 10,000 individual strands or filaments; between 100 and 5,000 individual strands or filaments; between 100 and 1000 individual strands or filaments; between 500 and 1000 individual strands or filaments; between 750 and 1000 individual strands or filaments and will have filament diameter proportions accordingly. Without being bound to any theory, it is believed that the multifilament construction may provide enhanced strength to the associated elongated line device 10 in certain applications. Additionally, it has been found quite unexpectedly that multifilament construction has advantageous attributes during biodegradation and/or environmental degradation cycles and/or when the elongated line device 10 is inadvertently discarded into the environment at large. Without being bound to any theory, it is believed that as the various polymeric materials present in the elongated line device 10 or portions thereof degrade, portions of the various layers such as those that make up sheath 12 can detach or become disassociated from contact with the elongated core 12. This results in portions of the elongated core 12 being exposed. Once significant portions of the elongated core 12 are exposed, the individual strands or filaments 12a, 12b are able separate from one another, exposing greater surface area to decomposition and/or degradation processes. Additionally, the exposed filaments or strands 12a, 12 b are easier to snap or break in the event that fish or land animals becomes entangled in a portion of the elongated line device left or lost in the wild. This separation phenomenon is illustrated in FIGS. 5-8 where portions of the core member of the elongated line 10 remain bundled by sheath 12 and portions are exposed and subject to separation.

In certain embodiments, the high molecular weight strain hardened polymeric matrix employed in the elongated core 12 can include one or more biodegradability enhancing additives or components. “Biodegradability” as the term is employed in this disclosure can be defined as the degree and rate of aerobic biodegradation of plastic or polymeric materials when the material is in contact with soil as outlined in ASTM D 5988-18 and its equivalent ISO 17556. For purposes of the present disclosure, effective biodegradability of the subject polymeric material is greater than 50% at 30 days. It has been found unexpectedly that the inclusion of an effective amount of a suitable biodegradability additive into the high molecular weight strain hardened polymeric matrix employed in the elongated core 12 can achieve the desired biodegradability standards.

Suitable additives include materials such as sulfonamide plasticizer compounds can be those include various substituted and non-substituted alkyl sulfonamides. Substituted and non-substituted alkyl sulfonamides employed in the high molecular weight strain hardened polymeric matrix can have the general formula:

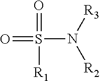

wherein R¹ is a substituted or unsubstituted aryl group;
R² is a substituted or unsubstituted C-2 to C-10 alkyl group, or a substituted or unsubstituted C-3 to C-10 alkenyl group; and
R³ is hydrogen.

In certain embodiments R¹ can be a substituted or unsubstituted phenyl group. In certain embodiments, the R² can be an unsubstituted C-2 to C-10 alkyl group and more particularly can be selected from the group consisting of ethyl, butyl, propyl and mixtures thereof. In certain embodiments, the additive can be N (n-butyl)benzene sulfonamide, o-tolylethylsulfonamide, p-tolylethylsulphonamide and mixtures thereof in an amount between 0.1% and 2.5%. In certain embodiments, the additive can be n-butylbenzene sulfonamide present in an amount between 0.1 and 2.5%.

As discussed previously, the elongated line device 10 includes a first layer composed of an amorphous polymeric matrix comprising cellulose ester compounds. In the embodiment depicted in FIGS. 1, 2A, 3A, 4 and 5 the first layer is configured as a sheath 14 surrounding and overlaying the outer surface 16 of elongated core 12. The polymeric material of the first layer that is configured as sheath 14 is composed of a polymer having a flexibility value greater than flexibility of the material or materials employed in the elongated core 12. In certain embodiments, the sheath 14 can be composed of a polymeric material having a tensile strength less than the tensile strength of the elongated core 12. The material of choice can be one that has density between 1.0 and 1.4 g/cm 3; a tensile strength between 25 and 40 MPa; flexural modulus between 1 and 2 (GPa) a glass transition temperature between 125° C. and 140° C.

The polymeric material employed in sheath 14 can be one that provides the sheath 14 with a bending and/or shear stiffness greater than the bending and/or shear stiffness of the associated elongated core 12. Amorphous polymeric material having a melt temperature greater than greater than 120° C. and a glass transition temperature greater than 85° C. can be employed in certain embodiments. Suitable materials can include mixed cellulose esters.

In certain embodiments, it is desirable that the cellulose component of the cellulose ester polymeric material employed in the sheath 14 be derived in whole or in part from naturally derived cellulose with bio-content values between 20% and 60% being possible in certain situations where bio-content value is determined by using six bio-based carbon atoms per anhyroglucose unit divided by the total number of carbons per anhyroglucose unit. In certain embodiments, the bio-content can be between 20% and 55%; between 20% and 50%; between 20% and 45%; between 20% and 40%; between 20% and 35%; between 20% and 30%; between 20% and 25%; between 25% and 55%; between 25% and 50%; between 25% and 45%; between 25% and 40%; between 25% and 35%; between 25% and 30%; between 30% and 55%; between 30% and 50%; between 30% and 45%; between 30% and 40%; between 30% and 35%; between 35% and 55%; between 35% and 50%; between 35% and 45%; between 35% and 40%; between 40% and 55%; between 40% and 50%; between 40% and 45%; between 45% and 55%; between 45% and 50%; between 25% and 45%; between 25% and 40%.

Where desired or required, the cellulose ester polymer is selected from the group consisting of cellulose acetate polymers, cellulose acrylate polymers, cellulose propionate polymers and mixtures thereof. In certain embodiments, the cellulose ester polymer can be selected from the group consisting of cellulose acetate propionate, cellulose acetate butyrate, cellulose acetate pentanoate and mixtures thereof. In certain embodiments, the cellulose ester polymer can be cellulose acetate butyrate and/or cellulose acetate propionate. Nonlimiting examples of suitable commercial sources of cellulose acetate butyrate and/or cellulase acetate propionate are those available commercially available from Eastman Chemical under the trade name Tenite.

Suitable material can be cellulose acetate butyrate materials with a buteryl content between 15 and 60 wt % and an acetyl content between 10 and 35 wt % in certain embodiments. Non-limiting examples of cellulose acetate butyrate polymeric materials suitable for use in the present disclosure are listed in Table III.

TABLE III
Physical properties of selected Cellulose Acetate Butyrate materials

| | CAB- | CAB | CAB- | CAB- | CAB- | CAB- | CAB- | CAB- | CAB- | CAB- | CAB | CAB- |
|---|---|---|---|---|---|---|---|---|---|---|---|---|
| Formulation¹ | 171-15 | 321-0.1 | 381-0.1 | 381-2 BP | 381-2 | 531-1 | 351-0.01 | 381-20 | 500-5 | 531-1 | 551-0.2 | 553-0.4 |
| Buteryl | 16.5-19 | 32.5 | 37 | 36 | 38 | 50 | 52 | 35.5 | 15 | 50 | 52 | 46 |
| wt % | | | | | | | | | | | | |
| Hydroxyl % | 0.8-1.4 | 1.3 | 1.5 | 1.7 | 1.7 | 1.7 | 2.0 | 0.8 | 1 | 1.7 | 1.8 | 4.8 |
| Acetyl | 28-31 | 28-31 | 13 | 14.5 | 13.5 | 2.8 | 2.0 | 15.5 | 4.0 | 2.8 | 2.0 | 2.0 |
| wt % | | | | | | | | | | | | |
| Melt | — | 151-165 | 155-165 | 175-185 | 171-184 | 135-150 | — | — | 165-175 | 135-150 | — | 150-160 |
| pt ° C. | | | | | | | | | | | | |
| T_{g}² ° C. | 161 | — | 123 | 130 | 130 | 115 | 85 | 128 | 96 | 115 | 101 | 136 |
| Hardness³ | 27 | 21 | 18 | 18 | 18 | 15 | 15 | 18 | 14 | 15 | 15 | 18 |
| Viscosity⁴ | 57.4 | 0.38 | 0.38 | 8.41 | 8 | 5.6 | 0.38 | 20.8 | 19 | 5.6 | 0.76 | 1.14 |
| Specific | 1.26 | — | — | 1.2 | 1.2 | 1.17 | 1.16 | 2.0 | 1.18 | 1.17 | 1.16 | — |
| gravity | | | | | | | | | | | | |

¹Eastman formulation name
²Glass transition Temperature
³Tukon Hardness in Knoops
⁴stated in poise and determined by ASTM Method D 1343. Results converted to poises (ASTM Method D 1343) using the solution density for formula as stated in ASTM D 817 (20% cellulose eater, 72& acetone, 8$ ethyl alcohol)

The polymeric material employed in the first layer such as sheath 14 can also include an effective amount of one or more plasticizer additives. Various classes of plasticizers suitable for use as a plasticizer additive in the polymeric material employed in the sheath 14 can include compatible materials having sulfonamide structures or linkages, or azide groups or linakges or nitramide linkages. Suitable compounds include, but are not limited to, substituted and unsubstituted alkyl sulfonamides, formal-acetal mixtures, glycidyl azides, substituted and unsubstituted nitramines, azidoacetates and the like. Non-limiting examples of formal-acetal mixtures include compounds such as bis(2,2-dinitro propyl) formal/acetal (BDNPF/A or A3) present in a suitable ratio such as 1:1. Non-limiting examples of suitable azidoacetate compounds include compounds such as ethylene glycol bis(azidoacetate) (EGBAA), diethylene glycol bis(azidoacetate) (DEGBAA), trimethylol nitromethane tris (azidoacetate) (TMNTA) and pentaerythritol tetrakis (azidoacetate) [PETKAA] and the like. Non-limiting examples of suitable substituted and unsubstituted nitramines include compounds such as n-butyl-N-(2-nitroxy-ethyl) nitramine (Bu-NENA).

Suitable sulfonamide plasticizers can be those include various substituted and non-substituted alkyl sulfonamides having the general formula:

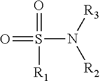

wherein R¹ is a substituted or unsubstituted aryl group;
R² is a substituted or unsubstituted C-2 to C-10 alkyl group, or a substituted or unsubstituted C-3 to C-10 alkenyl group; and
R³ is hydrogen.

In certain embodiments R¹ can be a substituted or unsubstituted phenyl group. In certain embodiments, the R² can be an unsubstituted C-2 to C-10 alkyl group and more particularly can be selected from the group consisting of ethyl, butyl, propyl and mixtures thereof.

Where desired or required, the plasticizer additive can be a compound such as N (n-butyl)benzene sulfonamide.

The polymeric material employed in the first layer such as sheath 14 can also include other suitable additives and/or fillers, including but not limited to, carbon particles, fiber glass and the like. Without being bound to any theory, it is believed that the presence of the additive such as carbon particles and/or cotton fiber and/or fiber glass can contribute to the biodegradability of the elongated line device 10, particularly fragmented portions thereof. When present particulate additives may be present in an amount between 2% by weight and 50% by weight of the polymeric material employed in the sheath 14. Where employed, fillers such as carbon, fiber glass, cotton fiber and the like can be employed.

It is also considered within the purview of this disclosure to include effective amounts suitable flame retardant compounds into the polymeric material of the first layer such as sheath 14 where desired or required. Nonlimiting examples of suitable flame retardant additives include various halogenated alkane sulfonate compounds and salts thereof. Non-limiting examples of such materials include various perflouroalkanesulfonic acids and salts thereof. Non-limiting examples of suitable perflouroalkanesulfonic acids include salts of nonaflurorbutanesulfonate, salts of hydroflurobutanesulfonate, and mixtures thereof. It is belvied that one such suitable material is commercially available from 3M under the trade designation FR-2025. In certain embodiments, the flame retardant compound(s) can be present in an amount between 0 and 10% vol %; between 0 and 5 vol %; between 2 and 10 vol %; between 5 and 10 vol %.

The elongated line device 10 as disclosed herein can have an average diameter suitable for the desired end use application. In certain embodiments where the elongated line device 12 can have an average diameter can be between 0.05 and 3 mm; between 0.05 and 2.5 mm; between 0.05 and 2 mm; between 0.05 and 1.5 mm; between 0.05 and 1 mm; between 0.05 and 0.8 mm; between 0.05 and 0.6 mm, between 0.07 and 3 mm; between 0.07 and 2.5 mm; between 0.07 and 2.0 mm; between 0.07 and 1.5 mm; between 0.07 and 1.0 mm, between 0.07 and 0.09 mm; between 0.09 and 3.0 mm; between 0.09 and 2.5 mm; between 0.09 and 2.0 mm; between 0.09 and 1.5 mm; between 0.09 and 1.0 mm; between 1.0 and 3.0 mm; between 1.0 and 2.7 mm; between 1.0 and 2.5 mm; between 1.0 and 2.2 mm; between 1.0 and 2.0 mm; between 1.0 and 1.7 mm; between 1.0 and 1.5 mm; between 1.0 and 1.3 mm; between 1.5 and 3.0 mm; between 1.5 and 2.5 mm; between 1.5 and 2.0 mm; 3.0 mm; between 1.5 and 3.0 mm; between 1.5 and 2.5 mm; between 1.5 and 2.0 mm; between 1.5 and 1.7 mm; between 2.0 and 3.0 mm between 2.5 and 3.0 mm; between 2.7 and 3.0 mm. Without being bound to any theory, it is believed that diameters in these ranges can be effectively employed in end use applications such as fishing lines, fishing netting, and the like.

It is also contemplated that, where desired or required, elongated line devices can be configured in other diameter ranges to accommodate other end use applications. Non limiting examples of such ranges include between 3 mm and 12 mm; 4 mm and 12 mm; 5 mm and 12 mm; 6 mm and 12 mm; 7 mm and 12 mm; 8 mm and 12 mm; 9 mm and 12 mm; 10 mm and 12 mm; 11 mm and 12 mm; 3 mm and 11 mm; 4 mm and 11 mm; 5 mm and 11 mm; 6 mm and 11 mm; 7 mm and 11 mm; 8 mm and 11 mm; 9 mm and 11 mm; 10 mm and 11 mm; 3 mm and 10 mm; 4 mm and 10 mm; 5 mm and 10 mm; 6 mm and 10 mm; 7 mm and 10 mm; 8 mm and 10 mm; 9 mm and 10 mm; 3 mm and 9 mm; 4 mm and 9 mm; 5 mm and 9 mm; 6 mm and 9 mm; 7 mm and 9 mm; 8 mm and 9 mm; 3 mm and 8 mm; 4 mm and 8 mm; 5 mm and 8 mm; 6 mm and 8 mm; 7 mm and 8 mm; 3 mm and 7 mm; 4 mm and 7 mm; 5 mm and 7 mm; 6 mm and 7 mm; 3 mm and 6 mm; 4 mm and 6 mm; 5 mm and 6 mm; 3 mm and 5 mm; 4 mm and 5 mm.

In its use configuration, the sheath 14 that surrounds and is connected to the elongated core 12 can exhibit a conformational connection with the outer surface 16 of the elongated core 12. In configurations where the elongated core 12 is composed of multiple elongated fibers oriented in a suitable weave or lay, the inner most edge 16 of sheath layer 14 can mold around portions of the outermost elongated fibers 12a, 12b making up the elongated core 12 and thereby provide a degree of mechanical connection between the respective layers. Without being bound to any theory, it is believed that the conformational connection between the polymeric materials present in the elongated core 12 and sheath 14 exhibit mechanical bonding, adhesive or chemical bonding or a combination of mechanical and adhesive or chemical bonding sufficient to permit use of the resulting elongated line device 10 in a variety of end use application including but not limited to string trimmer line, fishing implements such as fishing line, fishing net and the like as well as other end use applications. The bond strength and adhesive properties are maintained during the duty cycle and use of the elongated line device 10 in its end use application.

It has been unexpectedly discovered that, upon completion of the useful life and/or duty cycle, separation of initial portions of the sheath 14 from elongated core 12 can occur or be induced through environmental exposure and action. This particularly marked in induced in fragmentary segments having lengths of less 6 to 10 inches as would occur during breakage of the elongated line device 10 when used as fishing line, trimmer line or the like, for example. Without being bound to any theory, it is believed that induced separation between portions of the sheath 14 and the elongated core 12 can contribute to the ultimate biodegradability of the elongated line device 10 material which is lost or abandoned at the end of its useful life. Induced separation can be accomplished by fragmentation or breakage of the elongated line as can occur during various line trimmer operations. It is also contemplated that larger portions of the elongated line device 10 can also be subjected to induced separation between the layers due to prolonged biological or environmental action or the polymeric material present in the sheath layer 14. One illustration of the initiation stage of induced separation is presented in FIG. 5 in which environmental action has induced fractures in a length of elongated line device 10 abandoned in the exterior environment. Continued exposure and well as movement of the length of elongated line 10 induces separation S between segments 22 formed between fracture regions F. Further action results in peeling and flaking of portions of the sections of the polymeric material in the sheath 14 present in one or more of the segments 22 that have been created.

It has also been found unexpectedly that elongated line device structures as disclosed herein that include an elongated core 12 comprising a polymer selected from the groups consisting of a high molecular weight strain hardened polymeric matrix, a cellulose-derived fiber matrix and mixtures thereof and a sheath 14 surrounding and connected to the elongated core 14 in which the sheath is composed of an amorphous polymeric matrix comprising polymeric cellulose ester compounds can exhibit enhanced biodegradability over time when exposed to environmental conditions as would be found in various outdoor environments. Without being bound to any theory it is believed that enhanced biodegradability may be due, at least in part, to ability of fragmentary portions of the elongated line 10 undergoing induced separation between the sheath 14 and components of the elongated core 10.

One non-limiting mode of breakdown of the elongated line device 10 or fragments thereof as disclosed herein is illustrated in FIGS. 5-8 in which biodegradation of the polymeric material in the sheath layer 14 of discarded or lost elongated line device material can work alone or together with mechanical action inherent in the surrounding environment to induce the formation of gaps and cracks to in the sheath layer 14. This can promote flaking of portions of the sheath layer 14 away from the elongated core layer 12. This action produces smaller segments composed of the biodegradable sheath layer material which provide increased amounts of exposed surface area amenable to further biological and environmental degradation. This action also permits the development of greater regions of exposed elongated central core exposing it to biological and environmental degradation. The progressive action of the flaking of the sheath layer material away from the elongated core material also permits segment portions of the multiple elongated strands in the elongated core to separate and move independently of one another from one another in a manner such as that illustrated in FIGS. 5-8. Without being bound to any theory, it is believed that that the individual strands can be more easily snapped or broken than the bundled material and that this this action can contribute to the ability of entangled wildlife to extricate themselves from lengths of the elongated line 10 that have inadvertently been discarded in the environment.

In certain embodiments, the elongated line device 10 as disclosed herein can further include an outer coating layer 20 that is attached to the outer surface 18 of the sheath layer 14 as illustrated in FIG. 2B. Where desired or required, the outer coating layer 20 can adhere directly to the outer surface 18 of the sheath layer 14. The outer coating layer 20 can be composed of a polymeric material selected from the group consisting of polyethylene, polycarbonate and mixtures thereof. Suitable polyethylene materials, polypropylene materials, polycarbonate materials and mixtures thereof will be those that can be coextruded together with a CAB material sheath layer to form the elongated line device as disclosed. Example ranges for suitable materials are outlined in Table IV. Non-limiting examples of commercially available material include RTP 300 Polycarbonate, RTP 700 high density polyethylene and the like. Also suitable for such applications are polycarbonates such as Makrolon 2407.

Heretofore, it had been believed that polymeric materials selected from the group consisting of polyethylene, polycarbonate and mixtures thereof would be unable to effectively adhere to amorphous polymeric matrix layers such as cellulose ester selected from the group consisting of cellulose acetate, cellulose acetate butyrate, cellulose acetate propionate and mixtures thereof. It has been found unexpectedly that the use of such materials in an outer layer 20 overlying the outer surface 16 of sheath layer 14 of the can bond effectively to the sheath layer and can increase the use durability of the associated elongated line device 10 even at millimeter and submillimeter thicknesses. In certain embodiments, the outer layer 20 can have a thickness between 0.0005 mm and 0.05 mm; between 0.0005 mm and 0.04 mm; between 0.0005 mm and 0.03 mm; 0.0005 mm and 0.02 mm; 0.0005 and 0.01 mm; between 0.0005 mm and 0.007 mm; between 0.0005 mm and 0.005 mm; between 0.0005 mm and 0.002 mm; between 0.0005 mm and 0.001 mm; 0.00075 mm and 0.05 mm; between 0.00075 mm and 0.04 mm; between 0.00075 mm and 0.03 mm; 0.00075 mm and 0.02 mm; 0.00075 and 0.01 mm; between 0.00075 mm and 0.007 mm; between 0.00075 mm and 0.005 mm; between 0.00075 mm and 0.002 mm; between 0.00075 mm and 0.001 mm; 0.001 mm and 0.05 mm; between 0.001 mm and 0.04 mm; between 0.001 mm and 0.03 mm; 0.001 mm and 0.02 mm; 0.001 and 0.01 mm; between 0.001 mm and 0.007 mm; between 0.001 mm and 0.005 mm; between 0.001 mm and 0.002 mm; 0.003 mm and 0.05 mm; between 0.003 mm and 0.04 mm; between 0.003 mm and 0.03 mm; 0.003 mm and 0.02 mm; 0.003 and 0.01 mm; between 0.003 mm and 0.007 mm; between 0.003 mm and 0.005 mm; between 0.005 mm and 0.05 mm; between 0.005 mm and 0.04 mm; between 0.005 mm and 0.03 mm; 0.005 mm and 0.02 mm; 0.005 and 0.01 mm; between 0.007 mm and 0.05 mm; between 0.007 mm and 0.04 mm; between 0.007 mm and 0.03 mm; 0.007 mm and 0.02 mm; 0.007 and 0.01 mm.

It is contemplated that where employed, the coating layer can have a thickness between 0.001 mm and 0.5 mm; 0.001 mm and 0.4 mm; 0.001 mm and 0.3 mm; 0.001 mm and 0.2 mm; 0.001 and 0.1 mm; 0.001 mm and 0.05 mm; 0.001 mm and 0.025 mm; 0.001 mm and 0.01 mm; 0.001 mm and 0.005 mm; 0.001 mm and 0.004 mm; 0.001 mm and 0.003 mm; 0.003 mm and 0.5 mm; 0.003 mm and 0.4 mm; 0.003 mm and 0.3 mm; 0.003 mm and 0.2 mm; 0.003 and 0.1 mm; 0.003 mm and 0.05 mm; 0.003 mm and 0.025 mm; 0.003 mm and 0.01 mm; 0.003 mm and 0.005 mm.

In certain embodiments, the one or more layers such as the sheath layer and/or the coating layer can include one or more additives such delustering agents and the like.

According to a further aspect of the present disclosure, the elongated device 10 can be configured such that the first layer is configured as a central elongated core 15 and the at least one second layer overlies the first layer and is composed of a polymeric material that differs from the amorphous polymeric matrix comprising cellulose ester employed in the first layer. In certain embodiments, the second layer comprises a polymer selected from the group consisting of polyethylene, polycarbonate and mixtures thereof. A cross-sectional illustration of a configuration of this embodiment is depicted in FIG. 3B.

In the embodiment as illustrated in FIG. 3B, the first layer is configured as a central core element 15 and is an amorphous polymeric matrix having a melt temperature greater than greater than 120° C. and a glass transition temperature greater than 85° C. In certain embodiments, the amorphous polymeric matrix is composed of a cellulose ester polymer selected from a group consisting of cellulose acetate, cellulose acetate butyrate, cellulose acetate propionate and mixtures thereof. Where desired or required, the polyreme employed in the central core element can have the characteristics and composition described previously in conjunction with the sheath 14.

The central core element 15 will have an outer surface 17 and can be configured with any suitable cross-sectional profile. Non-limiting examples of such configurations include circular, ovoid, triangular, rectangular, ridges, angles, ridges, and the like. In the embodiment depicted in FIG. 3B, the cross-section is circular. The second layer is present on the outer surface 17 of the elongated line device in an overlying adhering relationship.

The central core element 15 will can have a diameter sufficient to provide structural integrity and strength to the elongated line device 10. The ratio of central core element diameter to total average diameter of the elongated line device 10 can vary based on the desired end-use application. In certain embodiments, the diameter of the central core element 15 can constitute between 50% and 99.75% of the total average diameter of the elongated line device 10. In certain embodiments, the diameter of the central core element 15 can constitute between 70% and 99.75%; between 80% and 99.75%; between 90% and 99.75%; between 95% and 99.75%; between 98% and 99.75%; between 99% and 99.75%.

In certain embodiments, the second layer of the elongated line device 10 as depicted in FIG. 3B, the can be configured as a an outer coating layer 20 and can overly and adhere to the outer surface 17 of central core element 15. The outer layer can have a thickness sufficient to impart surface strength and toughness to the outer surface of the associated elongated line device 10. In certain embodiments, the thickness can be between 1/1000 inch and 100/1000 inch; between 1/1000 inch and 50/1000 inch; between 1/1000 inch and 25/1000 inch; between 1/1000 inch and 10/1000 inch between 1/1000 inch and 5/1000 inch; between 1/1000 inch and 3/1000 inch; between 1/1000 inch and 2/1000 inch; between 2/1000 inch and 5/1000 inch; between 2/1000 inch and 4/1000 inch; between 3/1000 inch and 4/1000 inch; between 3/1000 inch and 5/1000 inch between 4/1000 inch and 5/1000 inch.

The outer coating layer 20 of the elongated line device 10 can be composed of a polymeric material selected from the group consisting of polyethylene, polycarbonate and mixtures thereof. Suitable polyethylene materials, polypropylene materials, polycarbonate materials and mixtures thereof will be those that can be coextruded together with a CAB material sheath layer to form the elongated line device as disclosed. Example ranges for suitable materials are outlined in Table IV. Non-limiting examples of commercially available material include RTP 300 Polycarbonate, RTP 700 high density polyethylene and the like. Also suitable for such applications are polycarbonates such as Makrolon 2407.

According to a further aspect of the present disclosure, a method for producing an elongated line device 10 is proposed, in which the elongated core 12 is provided which has at least one polymeric filament composed of a high molecular weight strain hardened polymeric matrix selected from the group consisting of polyphenylene terephthalamide, ultra-high molecular weight polyethylene and mixtures thereof. In certain aspects, the method for producing the elongated line device can have an elongated core that is composed of a plurality of polymeric filaments composed of a high molecular weight strain hardened polymeric matrix selected from the group consisting of meta-polyphenylene terephthalamide, para-polyphenylene terephthalamide, and mixtures thereof.

The elongated line device 10 that is produced by the method disclosed also includes a sheath 14 that surrounds and is connected to the elongated core that is composed of an amorphous polymeric matrix comprising cellulose ester. The amorphous polymeric matrix material of the sheath layer 14 can be polymer or polymeric blend having a melt temperature greater than greater than 120° C. and a glass transition temperature greater than 85° C. In certain embodiments, the amorphous polymeric matrix material is composed of a cellulose ester selected from the group consisting of cellulose acetate, cellulose acetate butyrate, cellulose acetate propionate and mixtures thereof.

The elongated line device 10 that is produced can also include an outer layer 20 that is connected to the outer surface of sheath 14 where desired or required.

In the method as disclosed herein, melted amorphous polymeric matrix comprising cellulose ester can be introduced into contact with the elongated core 12 in any suitable manner that will provide an outer coating layer 20 to the elongated line device 10.

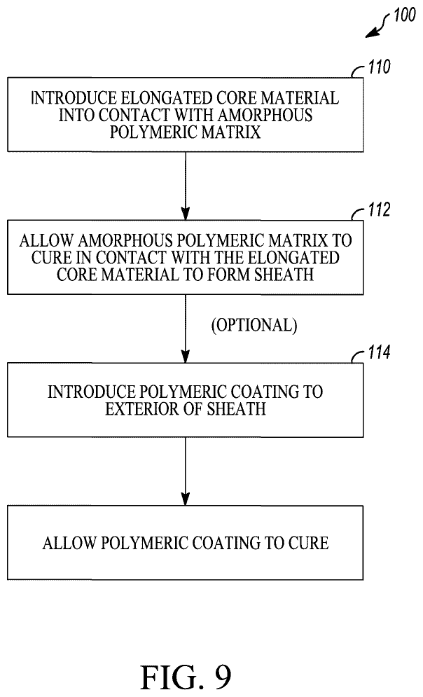

The elongated line device 10 as disclosed herein can be produced by any suitable method. A non-limited example of a process for producing the elongated line device 10 as disclosed herein is outlined in FIG. 9. In the process outlined in FIG. 9, it is contemplated that the elongated core material present in the elongated core 12 can be composed of either a unitary core monofilament or a plurality of filaments that can be twisted or braided or intertwined to form a yarn bundle as discussed previously. Formation of the elongated core 12 can occur upstream of the production process as disclosed. It is contemplated that the elongated core material can be fed into the process as a preassembled fiber bundle or can be spun or laid as needed in assembly operations upstream of the process as disclosed. In the process as disclosed herein, the elongated core material is brought into contact with the amorphous polymeric matrix material that will compose the sheath 14 as at reference numeral 110 to form the elongated core material.

Introduction of the elongated core material into contact with the amorphous polymeric material as at reference numeral 110 can be accomplished in a manner which facilitates the amorphous polymeric coating material to contact and adhere to the outer surface of the elongated core material in a uniform or essentially uniform manner and thickness. To accomplish this, the contact between the elongated core material and the amorphous polymeric matrix occurs while the amorphous polymeric material is held at a temperature above its associated melt temperature. While the contacting process as disclosed herein contemplates processes whereby, the elongated core material is drawn through a volume or successive volumes of molten amorphous polymeric material, in certain embodiments, it is contemplated that contact between the elongated core material and the amorphous polymeric matrix can be accomplished by positive application of the amorphous polymeric material to the outer surface of the elongated polymeric core material by processes such as cross-head extrusion or co-extrusion.

Once the contacting step is complete, the amorphous polymeric matrix can be allowed to cure in contact with the elongated core material to form a sheath around the elongated core material as at reference numeral 112. Where an outer coating layer is required, the process as depicted in FIG. 9 can include the optional step of introducing a polymeric coating into contact with the exterior surface of the sheath layer as at reference numeral and allowing the polymeric coating to cure.

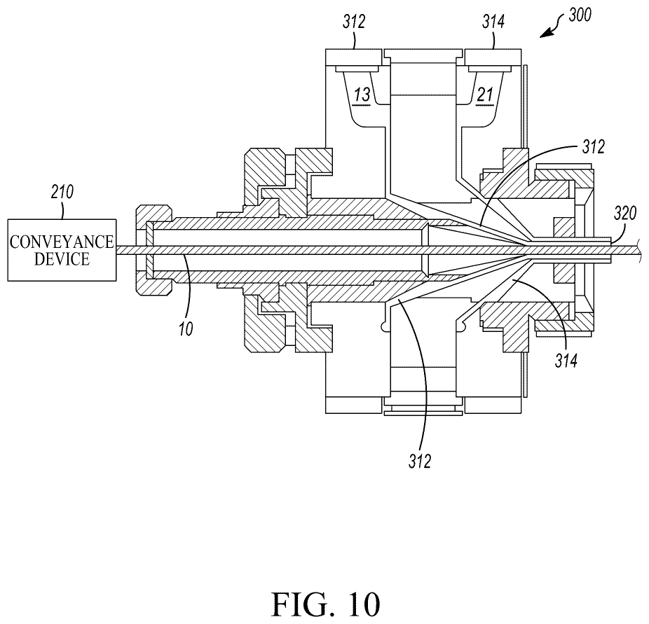

To accomplish contact, the elongated core material 10 can be positioned relative to a suitable conveyance device as at reference numeral 210 in FIG. 10. The conveyance device employed can include suitable tensioners, feeding devices, etc. as required to introduce the elongate core material into position for contact with the sheath material therearound as can be accomplished in extrusion device 300 as illustrated in FIG. 10.

In order to introduce sheath material, the amorphous polymeric matrix 312 from which the sheath is to be formed can heated to a suitable flow temperature and can be introduced through a suitable extrusion head as an extrudate that ultimately brings it into contact with the elongated core material in extrusion device 300. The extrudate can be fed into contact with the elongated core material in either a coaxial or perpendicular manner to form and encase the associated elongated core 10 with sheath material 312 of a suitable thickness. In certain embodiments the amorphous polymer matrix can be introduced by a co-extrusion head device, a non-limiting example of which is depicted in FIG. 10.

The amorphous polymeric matrix material extrudate released by an extruder is then molded onto the elongated core. Non-limiting examples of a suitable extruder for used in present process include screw extruders or piston extruders, in which the screw or the piston is used to convey the amorphous polymeric matrix extrudate out through an appropriate extrusion opening. The amorphous polymeric matrix material from which the sheath is made can be fed into the extruder in the form of granules pellets or the like as desired or required.

In certain embodiments, the amorphous polymeric matrix that is employed in the method can be is a polymer having a melt temperature greater than greater than 120° C. and a glass transition temperature greater than 85° C. capable of being processed at extrusion temperatures up to and including 250° C. In certain embodiments the amorphous polymeric matrix can be one that is capable of being processed at temperatures up to and including 230° C. In certain embodiments, the amorphous polymeric matrix is composed of a cellulose ester selected from the group consisting of cellulose acetate, cellulose acetate butyrate, cellulose acetate propionate and mixtures thereof and can be processed at a temperature between 120° C. and 250° C.; between 120° C. and 230° C.; between 120° C. and 200° C.

It is contemplated that the extruder 300 may include a suitable on-board heater(s) (not shown) for heating amorphous polymeric matric material above its melting point, so that the extrudate is present as a liquefied material or at least a viscous plastic that can be conveyed to the suitable extrusion outlet by the extruder's own conveyor mechanism, such as the screw.

In cross-head application processes, extruder outlet can be stationary fixed relative to a suitable conveyance device that can regulate the passage of elongated core material. For this purpose, the elongated core material core can be guided past the stationary position in translation, preferably at a constant speed. At the stationary position at/near the outlet of the extruder, the elongated core comes into contact with the amorphous polymeric matrix extrudate.

If desired, a suitable forming means can be provided to ensure that the amorphous polymeric matrix extrudate is brought into a specific shape with respect to the elongated core. Such a forming means can, for example, comprise a tube which has a radially arranged inlet opening at the stationary position for receipt of the amorphous polymeric matrix extrudate. At this position, the amorphous polymeric matrix extrudate can flow into the interior of the forming tube. The elongated core 12 can be guided through one of the front openings 320 of device 300 by a suitable conveying means into and through the interior of the tube in the longitudinal axis of the tube. At the interior position, the amorphous polymeric material matrix extrudate is fed to the elongated core, which is passed at a constant speed, and the external shape for the casing is specified by the tube with, for example, a circular cross-section. Other external shapes such as square, triangle, star shape, etc. are conceivable.

The applied amorphous polymeric matrix extrudate can be permitted to cured subsequent to the molding step. Water cooling, ie passing the resulting elongated line device through a water bath, or air cooling may be employed. Where air cooling is employed air flow can be provided by a fan to apply cold air to the elongated line device.

Once cured, the elongated line device can be advanced for further formation into the desired end use application or can be stored in any suitable manner. In certain situations, the elongated line device can be rolled onto a suitable spool if desired or required. It has been found quite unexpectedly that when rolled, the elongated line device exhibits little or no shape memory upon unrolling.

In one non-limiting example of a suitable method for producing an elongated line device as disclosed herein is co-extrusion of the amorphous polymeric matrix around elongated line material. A non-limiting example of a suitable co-extrusion head is presented in FIG. 10. In such processes, it is contemplated that the elongated core material 12 can be fed into an extrusion device and/or drawn through a device such as device 300 by any suitable means such as conveyance device 210. Coaxial to the elongated core material 12 are one or more amorphous polymer extrusion gates and flow path 312 which can meter introduction of amorphous polymeric material 13 onto the outer surface of the elongated line core material 12 as it is conveyed therethrough. Where desired or required, an outer coating material 21 can be introduced into overlaying contact with the outer surface formed by the introduced amorphous polymeric material at a location suitably downstream of the one of more amorphous polymer material extrusion gates and flow path 312 through coating material gates and flow path 314. Were desired or required, the extrusion gates and flow path 312 and coating gates and flow path 314 can be positioned such that thermal temperatures of the applied amorphous polymeric coating material and the applied coating material are complementary for application purposes.

Where desired or required, the amorphous polymeric matrix material can be a material as described previous in this disclosure and can be introduced at extrusion temperatures up to and including 250° C. In certain embodiments the amorphous polymeric matrix material can be introduced at temperatures up to and including 230° C. In certain embodiments, the amorphous polymeric matrix is composed of a cellulose ester selected from the group consisting of cellulose acetate, cellulose acetate butyrate, cellulose acetate propionate and mixtures thereof and can be introduced at a temperature between 120° C. and 250° C.; between 120° C. and 230° C.; between 120° C. and 200° C.

Where desired or required, the coating material can be a material as previously described in this disclosure. In certain embodiments, the coating material will have be a melt-processible polymeric material selected from the group consisting of polycarbonate, polyethylene, polypropylene, and mixtures thereof.

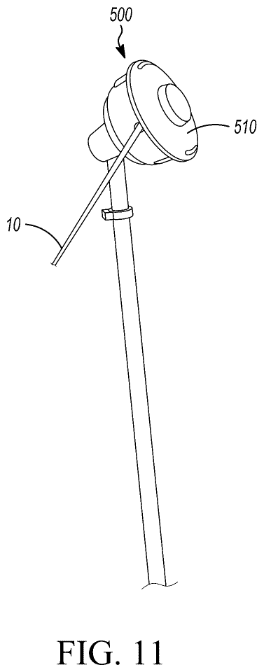

One non-limiting application for the elongated line device 10 as disclosed herein is in string trimmer devices such as rotary cutting device. A nonlimiting example of such a device is depicted in FIG. 11 at reference numeral. According to a further aspect of the present disclosure, a string trimmer device 500 or brush cutter is proposed containing an elongated lined device 10 according to one of the previous developments. A string trimmer 500 is a motor-powered device for mowing grass or other plants. A mowing head 510 is driven and rotated by an electric or combustion motor. Where desired or required, the mowing head 510 is preferably a thread head to which the elongated line device is fixed at one end. The elongated line device 10 rotates at high speed due to the drive and cuts the grass without a counter blade or counter bearing. In certain embodiments, it is contemplated that the elongated line 10 that is employed will comprise a first layer composed of an amorphous polymeric matrix comprising cellulose ester compounds and at least one second layer composed of a polymeric material that differs from the amorphous polymeric matrix comprising cellulose ester of the first layer in which the first layer is centrally positioned around a longitudinal axis through the elongated line device and the second layer surrounds the first in overlying contact therewith.

The following examples are provided to further illustrate the present disclosure. The examples are provided for illustration purposes and are not to be construed as limitative of the present invention as disclosed or claimed.

### Example 1

Various elongated line devices are prepared using an interior core of between 50 and 100 elongated fibers of KEVLAR 29 commercially available from Hercules Chemical having an average thickness between 5 and 50 microns are twisted to form an elongated core having an average diameter between and between 0.1 and 0.2 mm.

Sheath material is prepared by mix-melting cellulose acetate butyrate commercially available from Eastman under the trade name TENITE Butyrate 575E3720010 which is believed to have a specific gravity of 1.19 g/cm², tensile strength at break of 43.4 MPa (ASTM D638) and a flexural modulus of 1380 MPa (ASTMD790). The resulting material is extruded through a coextrusion device onto the interior core element as described to an average thickness between 0.5 mm and 1.5 mm and allowed to cure.

Portions are subjected to simulated wear and use conditions and are found to be durable and useful in applications such as fishing line, string trimmer line fishing netting. The material are then subjected to cutting and agitation to simulate breakage as could occur during usage and exposure to external forces. Portions of each elongated line device are tested according to ASTM D 5988-18 and are found to be biodegradable. The material tested exhibits approximately 30% degradation after 180 days.

The tested elongated line as well as virgin elongated line is then subjected to evaluate adhesion between the sheath and the elongated core of the various samples. The various samples are subjected to pulling tests to determine shear strength. At stretching forces between 20 lbs and 100 lbs., the sheath disengages from the associated core and can be removed in whole or in part therefrom exposing the individual strands of the sheath. It can be appreciated that such exposure can increase the surface area subject to interaction with biodegradative agents. FIGS. 5, 6, 7 and 8 illustrate elongated line device materials so processed.

### Example II

Additional samples having the elongated core and sheath as defined in Example I are prepared an outer coating layer of RTP 300 Polycarbonate at 2/1000 mm thickness by coextrusion. The resulting line device is evaluated. It is found that the polycarbonate outer layer adheres to the amorphous polymeric mater composed of cellulose ester without compromising the nature or function of the polymeric material present in the sheath. Side-by-side testing of samples prepared according to the process outlined in Example I and those prepared according to the process of Example II demonstrate improved toughness and durability of the line device prepared according to the process outlined in Example II. The test samples prepared according to the methods outlined in Examples I and II are also evaluated against monofilament nylon line of similar thickness and dimension and the test samples are found to be tougher and more durable than nylon lines.

### Example III

Samples of the elongated line device of Examples I and II are employed as fishing line in various fresh water and saltwater fishing activities. The test materials preformed as well or better than standard Nylon monofilament line.

### Example IV

Various elongated line constructs according to the disclosure is prepared having an inner core layer prepared by mix-melting cellulose acetate butyrate commercially available from Eastman under the trade name TENITE Butyrate 575E3720010 which is believed to have a specific gravity of 1.19 g/cm², tensile strength at break of 43.4 MPa (ASTM D638) and a flexural modulus of 1380 MPa (ASTMD790). The resulting material samples is extruded through a coextrusion device to form an interior core material having a thicknesses as described between 0.5 mm and 5.0 mm to which a layer of RTP 300 Polycarbonate at thickness between 1/1000 mm and 3/1000 mm is applied by coextrusion and allowed to cure.

The resulting elongated line constructions are evaluated for use performance by inserting them in string trimmer devices such as the string trimmer depicted in FIG. 11. Test comparison was accomplished using string trimmer devices employing nylon monofilament elongated line material at the same or similar thicknesses. It is found that the elongated line material as outlined in this example evidences similar or better performance characteristics as nylon monofilament.

### Example V

Samples of elongated line material prepared according to the process outlined in Example V are subjected to cutting and agitation to simulate breakage as could occur during usage and exposure to external forces. Portions of each elongated line device are tested according to ASTM D 5988-18 and are found to be biodegradable. The material tested exhibits approximately 30% degradation after 180 days.

While the invention has been described in connection with certain embodiments, it is to be understood that the invention is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An elongated line device comprising:
a first layer composed of an amorphous polymeric matrix comprising cellulose ester compounds; and
at least one second layer composed of a polymeric material that differs from the amorphous polymeric matrix comprising cellulose ester of the first layer.

2. The elongated line device of claim 1 wherein the polymeric material of the second layer comprises a polymer selected from a group consisting of polyethylene, polycarbonate and mixtures thereof.

3. The elongated line device of claim 2 wherein the first layer has an outer surface and wherein the second layer is in overlying relation to the first layer.

4. The elongated line device of claim 3 wherein the first layer is configured as a central core and the second layer is axially disposed relative to the first layer.

5. The elongated line device of claim 3, wherein the amorphous polymeric matrix of the first layer is a polymer having a melt temperature greater than greater than 120° C. and a glass transition temperature greater than 85° C.

6. The elongated line device of claim 5, wherein the amorphous polymeric matrix of the first layer is composed of a cellulose ester polymer selected from a group consisting of cellulose acetate, cellulose acetate butyrate, cellulose acetate propionate and mixtures thereof.

7. The elongated line device of claim 3 further comprising an elongated core disposed axially interior to the first layer such that the first layer forms a sheath surrounding and connected to the elongated core, the elongated core composed of at least one strand of a polymer comprising a high molecular weight strain hardened polymeric matrix.

8. The elongated line device of claim 7 wherein the high molecular weight strain hardened polymeric matrix of the elongated core comprises polyphenylene terephthalamide, ultra-high molecular weight polyethylene and mixtures thereof.

9. The elongated line device of claim 8 wherein the polyphenylene terephthalamide is selected from a group consisting of meta-polyphenylene terephthalamide, para-polyphenylene terephthalamide, and mixtures thereof.

10. An elongated line device comprising:
an elongated core, the elongated core composed of a plurality of elongated strands of a polymer comprising a high molecular weight strain hardened polymeric matrix; and
a sheath surrounding and connected to the elongated core, the sheath composed of an amorphous polymeric matrix comprising cellulose ester.

11. The elongated line device of claim 10 wherein the high molecular weight strain hardened polymeric matrix of the elongated core comprises polyphenylene terephthalamide, ultra-high molecular weight polyethylene and mixtures thereof.

12. The elongated line device of claim 11 wherein the polyphenylene terephthalamide is selected from the group consisting of meta-polyphenylene terephthalamide, para-polyphenylene terephthalamide, and mixtures thereof.

13. The elongated line device of claim 12, wherein the high molecular weight strain hardened polymeric matrix further comprises a biodegradability enhancing additive.

14. The elongated line device of claim 13 wherein the biodegradability enhancing additive is an alkyl sulfonamide present in an amount between 0 and 10%, the alkyl sulfonamide having general formula: 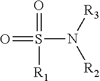
wherein R¹ is a substituted or unsubstituted aryl group;
R² is a substituted or unsubstituted C-2 to C-10 alkyl group, or a substituted or unsubstituted C-3 to C-10 alkenyl group; and
R³ is hydrogen.

15. The elongated line device of claim 10, wherein the elongated core has a tensile strength greater than the tensile strength of the sheath.

16. The elongated line device of claim 15, wherein the sheath has a bending and/or shear stiffness greater than the bending and/or shear stiffness of the elongated core.

17. The elongated line device of claim 11, wherein the amorphous polymeric matrix of the sheath is a polymer having a melt temperature greater than greater than 120° C. and a glass transition temperature greater than 85° C.

18. The elongated line device of claim 17, wherein the amorphous polymeric matrix of the sheath is composed of a cellulose ester selected from the group consisting of cellulose acetate, cellulose acetate butyrate, cellulose acetate propionate and mixtures thereof.

19. The elongated line device of claim 11 wherein the high molecular weight strain hardened polymeric matrix of the elongated core further comprises at least one plasticizer selected from the group consisting of benzene sulfonamide, n-butyl benzene sulfonamide, N (n-butyl)benzene sulfonamide, and mixtures thereof.

20. The elongated line device of claim 10 having a diameter between 0.05 and 7 mm.

21. The elongated line device of claim 10 further comprising an outer coating layer adhering to an outer surface of the sheath, the outer coating layer comprising a polymer selected form the group consisting of polyethylene, polycarbonate and mixtures thereof.

22. The elongated line device of claim 21, wherein at least one of the sheath and outer coating contains an effective amount of at least one of a pigment or a delustering agent.

23. An elongated line device comprising:
an elongated core, the elongated core composed of multiple strands of a polymeric material comprising a high molecular weight strain hardened polymeric matrix selected from the group consisting of polyphenylene terephthalamide, ultra-high molecular weight polyethylene and mixtures thereof;
a sheath surrounding and connected to the elongated core and having an outer surface, the sheath composed of an amorphous polymeric matrix comprising cellulose ester; and
an outer coating layer adhering to the outer surface, the outer coating layer comprising a polymer selected form the group consisting of polyethylene, polycarbonate and mixtures thereof.

24. The elongated line device of claim 23 wherein the polyphenylene terephthalamide is selected from the group consisting of meta-polyphenylene terephthalamide, para-polyphenylene terephthalamide, and mixtures thereof.

25. The elongated line device of claim 24 wherein the high molecular weight strain hardened polymeric matrix further comprises a biodegradability enhancing additive selected from the group consisting of an alkyl sulfonamide present in an amount between 0 and 10%, the alkyl sulfonamide having general formula: 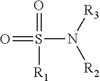
wherein R¹ is a substituted or unsubstituted aryl group,
R² is a substituted or unsubstituted C-2 to C-10 alkyl group, or a substituted or unsubstituted C-3 to C-10 alkenyl group, and
R³ is hydrogen.

26. A rotary cutting device comprising a string trimmer line composed of an elongated line device comprising:
at least one first layer composed of an amorphous polymeric matrix comprising cellulose ester; and
at least one second layer composed of a polymeric material that differs from the amorphous polymeric matrix comprising cellulose ester of the first layer.

27. A fishing implement comprising the elongated line device, an elongated line device comprising:
an elongated core, the elongated core composed of a plurality of elongated strands of a polymer comprising a high molecular weight strain hardened polymeric matrix; and
a sheath surrounding and connected to the elongated core, the sheath composed of an amorphous polymeric matrix comprising cellulose ester.

28. A method for producing an elongated line device having an elongated core composed of a high molecular weight strain hardened polymeric matrix and a sheath composed of a polymeric cellulose ester, the method comprising steps of:
conveying an elongated core member comprising a high molecular weight strain hardened polymeric matrix proximate to an extrusion orifice; and
introducing an extrudate into contact with the elongated core member through the extrusion orifice, wherein the extrudate comprises a cellulose ester selected from a group consisting of cellulose acetate, cellulose acetate butyrate, cellulose acetate propionate and mixtures thereof; and
forming a hardened sheath surrounding the extrudate around the elongated core member as the extrudate is conveyed away from the extrusion orifice.
